(19) United States
(12) Patent Application Publication
(10) Pub. No.: US 2002/0086808 A1
(43) Pub. Date: Jul. 4, 2002

(54) Active compound-containing emulsions

(76) Inventors: Peter-Roger Nyssen, Dormagen (DE); Iris Wiesinger, Leverkusen (DE); Hellmut-Martin Meier, Ratingen (DE); Udo Herrmann, Dormagen (DE)

Correspondence Address: BAYER CORPORATION, PATENT DEPARTMENT, 100 BAYER ROAD, PITTSBURGH, PA, 15205, US

(21) Appl. No.: 09/962,749

(22) Filed: Sep. 25, 2001

(30) Foreign Application Priority Data
Oct. 2, 2000 (DE) 10048 797.1

(51) Int. Cl. C11D 17/00; C11D 17/08

(52) U.S. Cl. 510/417; 510/475; 510/505

(57) ABSTRACT

The present invention relates to emulsions of an aqueous or aqueous-organic continuous phase and an organic discontinuous phase, wherein the organic discontinuous phase comprises

(a) at least one organic active compound having a water solubility at 20° C. of <10 g/l, and

(b) at least one organic compound having a water solubility at 20° C. of <1 g/l selected from the group consisting of the products of the reaction of alkylene oxides with alkylatable compounds, and

(c) optionally, a water-immiscible organic solvent, wherein component (a) is completely dissolved in component (b), or, when component (c) is present, in components (b) and (c) together, with a content of more than 0.1% by weight at 20° C., based on the total weight of the organic phase.

### BACKGROUND OF THE INVENTION

The invention relates to novel active compound-containing emulsions, to a process for their preparation and to their use.

In various areas, such as, for example, crop protection, protection of materials, and pharmaceutics, efforts have been made to prepare storage-stable active compound concentrates that can be introduced in dilute form into the application medium immediately prior to use. However, many active compounds are virtually completely water-insoluble or only poorly soluble in preferred organic solvents. The aim is, nevertheless, to make increasing use of aqueous active compound concentrates or active compound concentrates that are dilutable in aqueous media, such as, for example, active compound formulations in the form of suspension concentrates (“SC”) or emulsion concentrates (“EC”). In ECs, the active compounds are generally present in complete solution in one or more organic solvents that, in combination with emulsifiers, are emulsifiable in water. With respect to their emulsion stability and in particular also with respect to undesirable precipitation of the active compound as a crystalline solid in aqueous dilutions, there is still potential for improving the known formulations of ECs. This also applies with respect to increasing the active compound contents and the use of biodegradable or well tolerated solvents.

In the case of SCs, in particular aqueous SCs, it is in particular possible to achieve, as desired, higher active compound concentrations. However, the frequently insufficient biological activity is disadvantageous. Even very finely ground preparations of the active compounds with mean particle sizes in the submicron range do not achieve the desired biological activity.

Accordingly, it was an object of the present invention to provide a formulation system for active compounds in the form of active compound-containing emulsions, in particular microemulsions, that overcomes the above-described disadvantages.

It is another object to prepare emulsion concentrates that have high active compound contents and are based on well-tolerated components that are stable against flocculation, sedimentation, or creaming and also against crystallization or precipitation of solids (crystals of active compound) up to the high dilutions in water that are desired for application.

### SUMMARY OF THE INVENTION

Accordingly, the present invention relates to emulsions of an aqueous or aqueous-organic continuous phase and an organic discontinuous phase, wherein the organic discontinuous phase comprises

(a) at least one organic active compound having a water solubility at 20° C. of <10 g/l (preferably <1 g/l), and

(b) at least one organic compound having a water solubility at 20° C. of <1 g/l (preferably <0.1 g/l) selected from the group consisting of the products of the reaction of alkylene oxides with alkylatable compounds such as, for example, fatty alcohols, fatty amines, fatty acids, phenols, alkylphenols, carboxamides, and resin acids, and

(c) optionally, a water-immiscible organic solvent, wherein component (a) is completely dissolved in component (b), or, when component (c) is present, in components (b) and (c) together, with a content of more than 0.1% by weight (preferably >1% by weight, particularly preferably >10% by weight), at 20° C., based on the total weight of the organic phase.

### BRIEF DESCRIPTION OF THE DRAWINGS

FIG. 1 shows a continuous way of carrying out the process of the invention that optionally incorporates the jet dispersing process

FIGS. 2, 3, and 4 show particular embodiments of the mixing nozzle.

### DETAILED DESCRIPTION OF THE INVENTION

Organic active compounds or organic active substance compounds of component (a) in the context of this invention are to be understood as meaning bioactive, amorphous, or crystalline, synthetic or natural compounds. Bioactive substances that may be mentioned include those from the group of pharmaceutical active compounds and also plant protection agents, especially biocides, microbicides, pesticides, such as fungicides, bactericides, virucides, herbicides, insecticides, acaricides, nematicides, plant growth regulators, and bird repellents, and also disinfectants.

Of these, particular preference is given to active compounds having a melting point above 40° C.

Examples of fungicides that may be mentioned include 2-anilino-4-methyl-6-cyclopropylpyrimidine; 2′,6′-dibromo-2-methyl-4′-trifluoromethoxy-4′-trifluoromethyl-1,3-thiazole-5-carboxanilide; 2,6-dichloro-N-(4-trifluoro-methylbenzyl)benzamide; (E)-2-methoximino-N-methyl-2-(2-phenoxy-phenyl)acetamide; aldimorph, anilazine, azaconazole, azoxystrobin, benalaxyl, benomyl, bitertanol, blasticidin-s, bromuconazole, bupirimate, carbendazim, carboxin, chinomethionat (quinomethionate), chlorocresol (3-methyl-4-chlorophenol) chlorothalonil, cymoxanil, cyproconazole, carpropamid, dichlorophen, diclobutrazole, dichlofluanid, dicloran, diethofencarb, difenoconazole, dimethirimol, dimethomorph, diniconazole, dithianon, dodine, drazoxolon, epoxiconazole, ethirimol, etridiazole, fenarimol, fenbuconazole, fenhexamid, fenitropan, fenpiclonil, fenpropidin, fenpropimorph, fluazinam, fludioxonil, fluquinconazole, flusilazole, flusulfamide, flutolanil, flutriafol, fosetyl-aluminium, fthalide, fuberidazole, furalaxyl, guazatine, hexaconazole, hymexazole, imazalil, imibenconazole, iminoctadine, ibprobenfos (“IBP”), iprodione, isoprothiolan, iprovalicarb, kresoxim-methyl, mepanipyrim, mepronil, metalaxyl, metconazole, methasulfocarb, methfuroxam, metiram, myclobutanil, nuarimol, ofurace, oxadixyl, oxycarboxin, penconazole, pencycuron, probenazole, prochloraz, procymidon, propiconazole, propineb, pyrifenox, pyrimethanil, quintozene (“PCNB”), quinoxyfen, spiroxamine, tebuconazole, tecloftalam, tecnazene, tetraconazole, thiabendazole, thicyofen, thiophanate-methyl, thiram, tolyifluanid, triadimefon, triadimenol, triazoxide, trichlamid, tricyclazole, tridemorph, triflumizole, triforin, triticonazole, validamycin A, vinclozolin, zineb, ziram, 2-[2-(1-chlorocyclopropyl)-3-(2-chlorophenyl)-2-hydroxy-propyl]-2,4-dihydro-[1,2,4]-triazole-3-thione, and 1-(3,5-dimethyl-isoxazole-4-sulfonyl)-2-chloro-6,6-difluoro-[1,3]-dioxolo-[4,5-f]-benzimidazole.

Examples of bactericides that may be mentioned include bronopol, dichlorophen, nitrapyrin, octhilinon, oxytetracyclin, probenazole, streptomycin, and tecloftalam.

Examples of insecticides, acaricides and nematicides that may be mentioned include abamectin, alanycarb, aldicarb, amitraz, avermectin, AZ 60541, azocyclotin, 4-bromo-2-(4-chlorophenyl)-1-(ethoxymethyl)-5-(trifluoromethyl)-1 H-pyrrole-3-carbonitrile, bendiocarb, benfuracarb, bensultap, betacyfluthrin, bifenthrin, BPMC, brofenprox, bufencarb, buprofezin, butocarboxim, butylpyridaben, carbaryl, carbofuran, chlorfluazuron, N-[(6-chloro-3-pyridinyl)-methyl]-N′-cyano-N-methylethanimidamide, clofentezine, cyromazine, diafenthiuron, diazinon, dichlofenthion, diethion, diflubenzuron, dimethoate, dioxathion, disulfoton, emamectin, esfenvalerate, ethiofencarb, ethion, ethofenprox, fenamiphos, fenazaquin, fenbutatin oxide, fenitrothion, fenobucarb, fenothiocarb, fenoxycarb, fenpropathrin, fenpyrad, fenpyroximate, fenthion, fenvalerate, fipronil, fluazuron, flucycloxuron, flufenoxuron, flufenprox, fluvalinate, formothion, fosthiazate, fubfenprox, furathiocarb, hexaflumuron, hexythiazox, imidacloprid, isazophos, isofenphos, isoprocarb, isoxathion, ivermectin, lambda-cyhalothrin, lufenuron, mecarbam, methiocarb, methomyl, metolcarb, milbemectin, moxidectin, naled, NC 184, nitenpyram, omethoate, oxamyl, oxydemethon M, permethrin, phenthoate, phorate, phosalone, phoxim, pirimicarb, pirimiphos M, pirimiphos A, promecarb, propoxur, prothoat, pymetrozine, pyridaphenthion, pyrethrum, pyridaben, pyrimidifen, pyriproxifen, quinalphos, salithion, sebufos, silafluofen, sulfotep, sulprofos, spinosad, tebufenozide, tebufenpyrad, teflubenzuron, thiacloprid, thiafenox, thiamethoxan, thiodicarb, thiofanox, thiomethon, thionazin, triazuron, trichlorfon, triflumuron, trimethacarb, vamidothion, XMC, and xylylcarb.

Examples that may be mentioned of herbicides include acetamiprid, benzosulfuronmethyl, cyclosulfamuron, flucarbazone, procarbazone, sodium, flufenacet, diflufenican, propanil, chloridazon, norflurazon, desmedipham, phenmedipham, alachlor, acetochlor, butachlor, metazachlor, metalochlor, acifluorfen, bifenox, chlorotoluron, diuron, isoproturon, linuron, dichlobenil ioxynil, mefenacet, amidosulfuron, chlorimuron-ethyl, chlorsulfuron, cinosulfuron, methylsulfuron-methyl, nicosulfuron, primisulfuron, pyrazosulfuron-ethyl, thiofensulfuron-methyl, triasulfuron, tribenuron-methyl, atrazine, cyanazine, simazine, metamitron, metribuzin, glufosinate and glyphosate.

Examples of plant growth regulators that may be mentioned include chlormequat-methyl and ethephon.

Organic active compounds in the context of this specification are also to be understood as meaning organochemical compounds having a melting point of >40° C. and a solubility in water at 20° C. of preferably 10 g/l (more preferably <1 g/l). Of these, particular mention may be made of disperse dyes or solvent dyes, as described in Colour Index, 3rd. edition (3rd. revision 1987) under “Disperse Dyes” and in Colour Index, 3rd. edition (1982, Pigments and Solvent Dyes), respectively.

Preferred disperse dyes are carboxylic acid and/or sulfonic acid group-free nitro, amino, aminoketone, ketoimine, methine, polymethine, diphenylamine, quinoline, benzimidazole, xanthene, oxazine, cumarine, and in particular anthraquinone and azo dyes, such as mono- and diazo dyes. Particularly suitable disperse dyes are found, for example, in formulas 1) to 23) from EP 924,335 A1.

The organic compound of component (b) is preferably a nonionic compound selected from the group consisting of the reaction products of alkylene oxides with alkylatable compounds, such as, for example, fatty alcohols, fatty amines, fatty acids, phenols, alkylphenols, carboxamides, and resin acids. These are, for example, alkylene oxide adducts from the class of the reaction products of ethylene oxide and/or propylene oxide with

(b1) saturated and/or unsaturated fatty alcohols having 6 to 25 carbon atoms or

(b2) alkylphenols having 4 to 12 carbon atoms in the alkyl radical or

(b3) saturated or unsaturated fatty amines having 14 to 20 carbon atoms or

(b4) saturated and/or unsaturated fatty acids having 14 to 22 carbon atoms or

(b5) hydrogenated and/or non-hydrogenated resin acids, particularly gum rosin or abietic acid and turpentine resin or

(b6) esterification and/or arylation products, prepared from natural or modified, optionally hydrogenated castor oil fatty substances, wherein these products have optionally been linked by esterification with dicarboxylic acids to form structural repeating units.

Also suitable for use as compounds of component (b) are compounds (b7) selected from the group of the alkoxylated phenols, particularly phenol/styrene polyglycol ethers of the formula (I) or the formula (II)

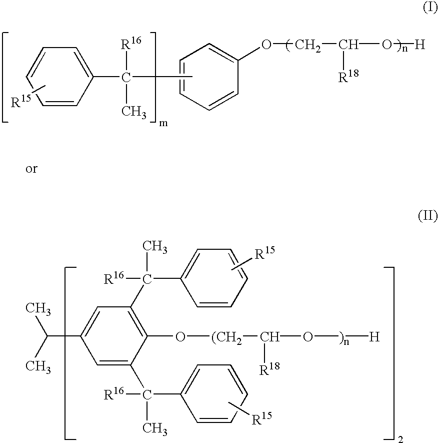

in which

R¹⁵ represents hydrogen or C₁-C₄-alkyl,

R¹⁶ represents hydrogen or CH₃,

R¹⁷ represents hydrogen, C₁-C₄-alkyl, C₁-C₄-alkoxy, C₁-C₄-alkoxy-carbonyl, or phenyl,

m represents a number from 1 to 4,

n represents a number from 2 to 13 (preferably from 2 to 8),

R¹⁸ for each unit indicated by n is identical or different and represents hydrogen, CH₃, or phenyl, subject to the proviso that (i) when CH₃ is present in the various —(—CH₂—CH(R¹⁸)—O—)— groups, then 0 to 60% of the total R¹⁸ is CH₃ and 40 to 100% of the total R¹⁸ is hydrogen and (ii) when phenyl is present in the various —(—CH₂—CH(R¹⁸)—O—)— groups, then 0 to 40% of the total R¹⁸ is phenyl and 60 to 100% of the total R¹⁸ is hydrogen.

The organic compounds of component (b) may in particular also be understood as “solvents” for the active compounds of component (a), which are themselves insoluble or very poorly soluble in water or aqueous-organic media in a temperature range of from 10 to 99° C. At room temperature, their solubility in water is preferably <1 g/l (preferably <0.1 g/l).

Particularly preferably, the organic compounds (b) also have surfactant properties and preferably have an arithmetic HLB [where HLB is the hydrophilic-lipophilic balance] value of less than 12 (preferably less than 10).

The selection of the compounds of component (b) depends primarily on the solubilizing power in the temperature range from 20 to 200° C. for the respective active compound of component (a) to be dissolved. Preferred is a high solubility of (a) in (b) or, if appropriate, of (a) in (b) and (c), of >5 g/l (preferably >10 g/l), in the temperature range mentioned.

Preferred organic compounds of component (b) are those of the formula (I) or (II) and also alkylene oxide adducts of the compounds (b5) and (b6), very particularly preferably of gum resin or abietic acid.

The water-immiscible organic solvents of component (c) preferably have a boiling point of >100° C. (preferably >130° C.), and a solubility in water of <1.0 g/l at 200C.

Preferred organic solvents (c) are natural, fully synthetic, or semisynthetic compounds and, if appropriate, mixtures of these solvents which, in the temperature range from 20 to 130° C., are fully miscible with the organic compounds (b) or soluble. Preference is given to solvents from the group of the aliphatic, cycloaliphatic, or aromatic hydrocarbons that are liquid at room temperature, particularly to

oils, such as, for example, mineral oils, paraffins, isoparaffins, fully synthetic oils, such as silicone oils, semisynthetic oils based, for example, on glycerides of unsaturated fatty acids of medium length, ethereal oils,

esters of natural or synthetic saturated or unsaturated fatty acids, preferably C₈-C₂₂-, preferably C₈-C₁₈-fatty acids, particularly preferably rapeseed oil methyl ester, or 2-ethylhexyl laurate,

alkylated aromatic compounds and mixtures thereof,

alkylated alcohols, preferably fatty alcohols,

linear primary alcohols obtained by hydroformylation,

terpene hydrocarbons, and

naphthenic oils, such as, for example, enerthenes.

Further preferred solvents of component (c) are those selected from the group of the acetate solvents, such as, for example, 1,2-propanediol diacetate, 3-methyl-3-methoxybutyl acetate, ethyl acetate, etc. These solvents can be used on their own or in mixtures with one another.

In addition to components (a) to (c), the organic discontinuous phase of the emulsions according to the invention may comprise further additives having a solubility in water of <0.1 g/l, but a solubility of >10 g/l in components (b) and/or (c).

Particularly suitable here are compounds from the group of the

sorbitan esters, such as, for example, SPAN® (ICI),

block copolymers based on ethylene oxide and/or propylene oxide, such as, for example, Pluronic® (BASF),

block copolymers of ethylene oxide and/or propylene oxide on bifunctional amines, such as, for example, Tetronic® (BASF),

block copolymers based on (poly)stearic acid and (poly)alkylene oxide, such as, for example, Hypermer® B (ICI),

polyvinylpyrrolidone and copolymers thereof, having a molecular weight of >100,000 g/mol, such as, for example, Luviskol K® (BASF), and

organic additives for masking odor and/or preventing solids from crystallizing, particularly cholesterol and/or vanillin, compounds selected from the group of the terpenes, terpenoids, fatty acids, and fatty acid esters, and particularly from the group of the ethereal oils, such as, for example, eucalyptol and other perfumes, particularly further perfume oils.

In a preferred composition, the organic discontinuous phase of the emulsions according to the invention comprises, based on the total discontinuous phase,

(a) from 0.5 to 40% by weight (preferably from 1 to 20% by weight) of at least one organic active compound, in particular bioactive compound,

(b) from 20 to 99.5% by weight (preferably from 40 to 99% by weight) of at least one organic compound of component (b), and

(c) from 0 to 80% by weight of an organic solvent of component (c).

The continuous aqueous or aqueous-organic phase (i.e., the carrier phase of the emulsion droplets) of the active compound-containing emulsions or microemulsions according to the invention preferably comprises

(d) water,

(e) optionally, organic solvent,

(f) optionally, a natural or synthetic surfactant that has a solubility in water of >10 g/l (preferably >100 g/l) at 20° C., and, if appropriate, further additives.

Preferred organic solvents of component (e) are water-soluble or water-miscible solvents, in particular those having a solubility in water of >5.0 g/l at 20° C. (preferably >15 g/l).

Suitable organic solvents are, for example, aliphatic C₁-C₄-alcohols, such as methanol, ethanol, isopropanol, n-propanol, n-butanol, isobutanol, or tert-butanol, aliphatic ketones, such as acetone, methyl ethyl ketone, methyl isobutyl ketone, or diacetone alcohol, polyols, such as ethylene glycol, propylene glycol, butylene glycol, 1,4-butanediol, 1,5-pentanediol, 1,6-hexandiol, diethylene glycol, triethylene glycol, tri-methylolpropane, polyethylene glycol, or polypropylene glycol having an average molecular weight of from 100 to 4000 g/mol(preferably from 200 to 1500 glmol), or glycerol, monohydroxy ethers, preferably monohydroxyalkyl ethers, particularly preferably mono-C₁-C4-alkylglycol ethers, such as ethylene glycol monoethyl ether or ethylene glycol monomethyl ether, diethylene glycol monomethyl ether or diethylene glycol monoethyl ether, diethylene glycol monobutyl ether, dipropylene glycol monoethyl ether, thiodiglycol, triethylene glycol monomethyl ether or triethylene glycol monoethyl ether, as well as 2-pyrrolidone, N-methyl-2-pyrrolidone, N-ethylpyrrolidone, N-vinylpyrrolidone, 1,3-dimethylimidazolidone, dimethylacetamide, and dimethylformamide.

Also suitable are mixtures of solvents, for example, of those mentioned. The amount of the solvent (e) employed in the aqueous continuous phase is generally less than 60% by weight, preferably less than 40% by weight, based on the continuous phase.

Surfactants (f) are preferably understood as meaning emulsifiers, wetting agents, dispersants, antifoams, or solubilizers that are completely soluble in the aqueous phase. In particular, they may be nonionic, anionic, cationic, or amphoteric and may be monomeric, oligomeric, or polymeric in nature. The selection of the surfactants (f) is not restricted in accordance with the invention and must be tailored to the discontinuous phase to be stabilized, comprising the components (a), (b), and, if appropriate, (c), with respect to the desired type of emulsion (for example, miniemulsion or microemulsion) and also in terms of emulsion stability, particularly with respect to sedimentation and/or creaming of the disperse phase.

Preferred surfactants of component (f) are those of (f1) to (f10):

(f1) Alkoxylation products, obtainable by alkoxylation with ethylene oxide or propylene oxide of condensation products of phenolic OH-containing aromatics with formaldehyde and NH-functional groups.

(f2) Water-soluble inorganic salts, especially borates, carbonates, silicates, sulfates, sulfites, selenates, chlorides, fluorides, phosphates, nitrates, and aluminates of the alkali metals and alkaline earth metals and of other metals, as well as ammonium.

(f3) Polymers built up from repeating succinyl units, especially polyaspartic acid.

(f4) Nonionic or ionically modified compounds selected from the group of the alkoxylates, alkylolamides, esters, amine oxides, and alkyl polyglycosides, especially reaction products of alkylene oxides with alkylatable compounds, such as fatty alcohols, fatty amines, fatty acids, phenols, alkylphenols, carboxamides, and resin acids, for example. These products comprise, for example, ethylene oxide adducts from the class of the reaction products of ethylene oxide with:

(m) saturated and/or unsaturated fatty alcohols having 6 to 25 carbon atoms or

(n) alkylphenols having 4 to 12 carbon atoms in the alkyl radical or

(o) saturated and/or unsaturated fatty amines having 14 to 20 carbon atoms or

(p) saturated and/or unsaturated fatty acids having 14 to 22 carbon atoms or

(q) hydrogenated and/or non-hydrogenated resin acids or

(r) esterification products and/or arylation products prepared from natural or modified, optionally hydrogenated castor oil fatty substances, wherein these products have optionally been linked by esterification with dicarboxylic acids to form structural repeating units.

(f5) Ionic or nonionic compounds selected from the group of the reaction products of alkylene oxide with sorbitan ester [Tween®, ICI], alkoxylated acetylenediols and acetylene glycols, alkoxylated phenols, especially phenol/styrene polyglycol ethers of formula (I) and (II) with the difference that n is a number from 14 to 120, and ionically modified phenol/styrene polyglycol ethers of formula (I) or (II) such as disclosed, for example, in EP-A 839,879 [or EP-A 764,695]. By ionic modification is meant, for example, sulfating, carboxylating, or phosphating. Ionically modified compounds can either be present in the form of their free acids or preferably as a salt, especially as an alkali metal or amine salt, preferably diethylamine salt.

(f6) Ionic or nonionic polymeric surfactants selected from the group of the homopolymers and copolymers, graft polymers, and graft copolymers, and also random and linear block copolymers.

Examples of suitable polymeric surfactants (f6) are polyethylene oxides, polypropylene oxides, polyoxymethylenes, polytrimethylene oxides, polyvinyl methyl ethers, polyethyleneimines, polyacrylic acids, polyarylamides, polymethacrylic acids, polymethacrylamides, poly-N,N-dimethylacrylamides, poly-N-isopropylacrylamides, poly-N-acrylglycinamides, poly-N-methacrylglycinamides, polyvinyloxazolidones, and polyvinylmethyloxazolidones.

(f7) Anionic surfactants such as, for example, alkyl sulfates, ether sulfates, ether carboxylates, phosphate esters, sulfosuccinate amides, paraffinsulfonates, olefinsulfonates, sarcosinates, isethionates, and taurates.

(f8) Anionic surfactants selected from the group of the dispersants, especially condensation products obtainable by reacting naphthols with alkanols, adding on alkylene oxide, and at least partly converting the terminal hydroxyl groups into sulfo groups, or monoesters of maleic acid, phthalic acid, or succinic acid; sulfosuccinic esters, alkylbenzenesulfonates, and also salts of polyacrylic acids, polyethylenesulfonic acids, polystyrenesulfonic acid, polymethacrylic acids, and polyphosphoric acids.

(f9) Lignin-type compounds, especially ligninsulfonates, e.g., those obtained by the sulfite or Kraft process. The products in question are preferably partly hydrolyzed, oxidized, propoxylated, sulfonated, sulfomethylated, or disulfonated and fractionated by known methods, for example, in accordance with the molecular weight or in accordance with the degree of sulfonation. Mixtures of sulfite and Kraft ligninsulfonates are also highly effective. Particularly suitable ligninsulfonates are those having an average molecular weight of greater than 1000 to 100,000 glmol and an active ligninsulfonate content of at least 80% and preferably having a low polyvalent cation content. The degree of sulfonation may vary within wide limits.

(f10) Amphoteric surfactants such as betaines and ampholytes, particularly glycinates, propionates and imidazolines.

Particular preference is given to betaines based on boric acid esters of the general formula (XV)

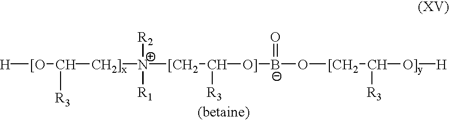

where

x and y are each a number from 1 to 50 (preferably from 2 to 30),

R₁ and R₂ are linear or branched C₆-C₁₈-alkyl, and

R₃ are each identical or different and represent hydrogen, CH₃, or phenyl, subject to the proviso that (i) when CH₃ is present in the various —(—CH₂—CH(R³)—O—)— groups, then 0 to 60% of the total R³ is CH₃ and 40 to 100% of the total R³ is hydrogen and (ii) when phenyl is present in the various —(—CH₂—CH(R³)—O—)— groups, then 0 to 40% of the total R³ is phenyl and 60 to 100% of the total R³ is hydrogen.

In a particularly preferred embodiment, the continuous aqueous phase may, in addition to the surfactants (f) mentioned, in particular (f1) to (f10), also comprise water-soluble block copolymers of component (g). These surfactants are preferably water-soluble block copolymers based on ethylene oxide and/or propylene oxide [Pluronic®, BASF] and/or water-soluble block copolymers of ethylene oxide and/or propylene oxide on bifunctional amines [Tetronic®, BASF].

Also suitable are block copolymers based on polystyrene and polyalkylene oxide, poly(meth)acrylates, and polyalkylene oxide and also poly(meth)acrylates and poly(meth)acrylic acids.

The continuous aqueous phase may additionally comprise further customary additives, such as, for example, water-soluble wetting agents, antifoams, and/or preservatives.

Based on the total emulsion, the emulsions according to the invention preferably comprise from 1 to 40% by weight (preferably from 2 to 20% by weight) of the discontinuous organic phase and from 60 to 99% by weight of the continuous aqueous or aqueous-organic phase.

Based on the discontinuous organic phase, preferred compositions of the emulsions comprise

from 0 to 2000% by weight (preferably from 1 to 1000% by weight, more preferably from 10 to 1000% by weight) of one or more water-soluble surfactants of component (f),

from 0 to 100% by weight (preferably from 1 to 50% by weight) of one or more water-soluble block copolymers of component (g), and

from 0 to 600% by weight (preferably from 20 to 400% by weight) of one or more water-soluble organic solvents of component (e), and

optionally, further customary additives.

If the emulsions are present as microemulsions, they preferably comprise, based on the discontinuous organic phase,

from 10 to 2000% by weight (preferably from 100 to 1000% by weight) of one or more water-soluble surfactants of component (f),

from 0 to 100% by weight (preferably from 1 to 50% by weight) of one or more water-soluble block copolymers of component (g), and

from 0 to 600% by weight (preferably from 20 to 400% by weight) of one or more water-soluble organic solvents of component (e), and

optionally, further customary additives.

Preferred emulsion types which may be mentioned are:

macroemulsion: containing drops >2 μm (microscopic),

miniemulsion: drop diameter 0.1 to 2 μm, preferably turbid,

microemulsion: drop diameter <0.1 μm, preferably transparent.

Particular preference is given to microemulsions.

Using the invention, it has surprisingly been possible to keep stable in solution at room temperature (20° C.) particularly high amounts of active compounds in the discontinuous phase—i.e., the emulsion droplets. In particular in the case of microemulsions (i.e., clear emulsions), it was possible to achieve considerably higher contents of active compounds (a) than was to be expected by the limiting solubility (b) determined at room temperature (20° C.), of the pure active compounds (a) in the organic compounds (b) and, if appropriate, solvent (c). Likewise surprisingly, it has been found that by using the microemulsions according to the invention, it is possible to prevent virtually completely diffusion of active compound into a surrounding medium, for example the surrounding atmosphere. Accordingly, the invention is also suitable for reducing or even preventing the volatility of active compounds or operating materials, in particular hazardous or odorous substances.

Accordingly, the invention also comprises a process for preparing the active compound-containing emulsions according to the invention, for example the macro- or microemulsions, in which the active compound (a) in question is completely dissolved at a temperature of from 20 to 200° C. in the organic compound (b), using, if appropriate, solvent (c), the solution is, if appropriate, filtered hot in the temperature range mentioned, and the resulting solution is then emulsified in the aqueous or aqueous-organic phase, while, of course, maintaining the temperature required for complete solubility of the active compound, and the resulting emulsion, for example, macro- or microemulsion, is cooled to a temperature of from 10 to 70° C. (preferably below 60° C.), and, if appropriate, finally filtered.

The process can also be carried out in the form of inverted emulsion, where initially part of the aqueous or aqueous-organic phase is introduced into the active compound-containing (oil) phase and emulsified (W/O type emulsion) and then converted by successive addition of the remainder of the aqueous phase into the desired emulsion (O/W type emulsion).

For dispersing (emulsifying), suitable processes include stirring, dissolver emulsifying, emulsifying by means of rotor/stator machines, Ultraturrax, high-pressure homogenizer, jet dispersing, and ultrasonic treatment. The choice of the particular method is dependent on the desired fine division of the discontinuous phase (i.e., macroemulsion, miniemulsion, or microemulsion).

The processes can be carried out both batchwise or continuously. In general, a continuous procedure is preferred, where the two phases can be mixed intensively and emulsified in a small space, if appropriate under pressure and with input of shear energy, and be cooled immediately afterwards, in the shortest possible time, to the temperature required for stabilizing the emulsion (with respect to precipitation of the active compound from the discontinuous phase (or from the organic compound (b)). Particularly preferred is a continuous procedure for obtaining microemulsions or miniemulsions having a maximum droplet size of the discontinuous phase of <1 μm (preferably <0.5 μm, very particularly preferably <0.1 μm). In general, the two phases are initially prepared separately, for example by dissolving and stirring the components, if appropriate at elevated temperature, and are then fed into an emulsifying apparatus, if appropriate continuously.

Preference is given to processes in which the emulsion operation is carried out with high energy input, for example by means of ultrasound or high-pressure homogenizing or jet dispersing at pressures of from 2 to 2500 bar(particularly from 20 to 1000 bar) in one or more passes. The particularly preferred jet dispersing process, and suitable apparatus, are illustrated, for example, in DE-A 19 536 845. By this process, and with appropriate temperature control, it is possible in particular to obtain microemulsions having a particularly high long-term stability and a very high content of active compound, which microemulsions can be used for the applications mentioned below.

Final adjustment to the desired properties such as viscosity, flow behaviour and preservation can take place before, during, or after emulsifying by adding water or other additives.

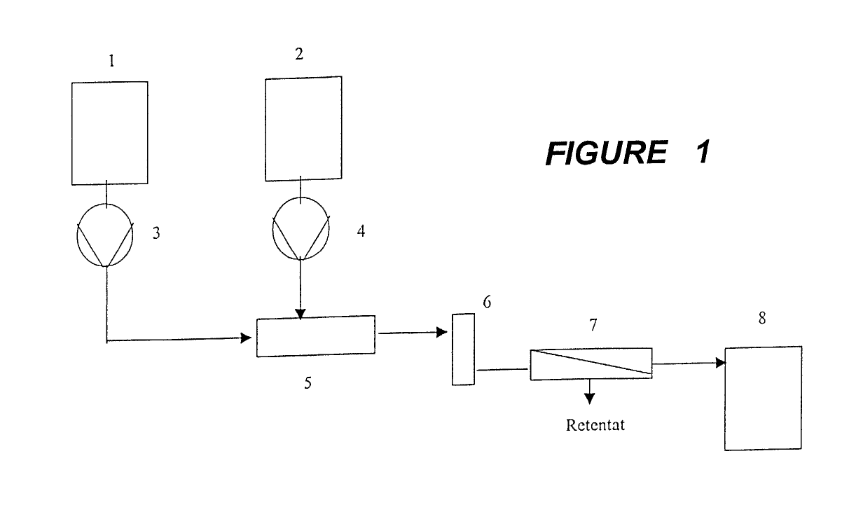

A preferred continuous way of carrying out the process, optionally incorporating the jet dispersing process, is shown in FIG. 1. In two receiving vessels 1 and 2, which may be heated and stirred, the discontinuous and continuous (aqueous) phases are prepared separately in each case and then combined and emulsified by means of pumps 3 and 4 in a mixing nozzle 5 and then introduced into container 8—if appropriate after cooling, for example, using a heat exchanger 6, and if appropriate after filtration through a microfiltration unit 7.

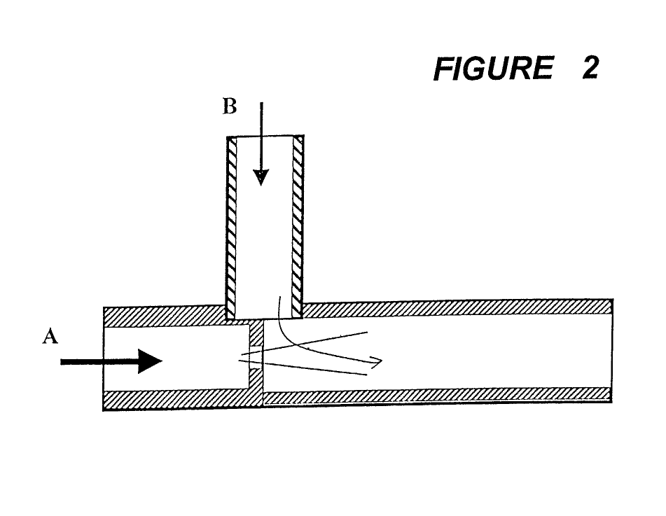

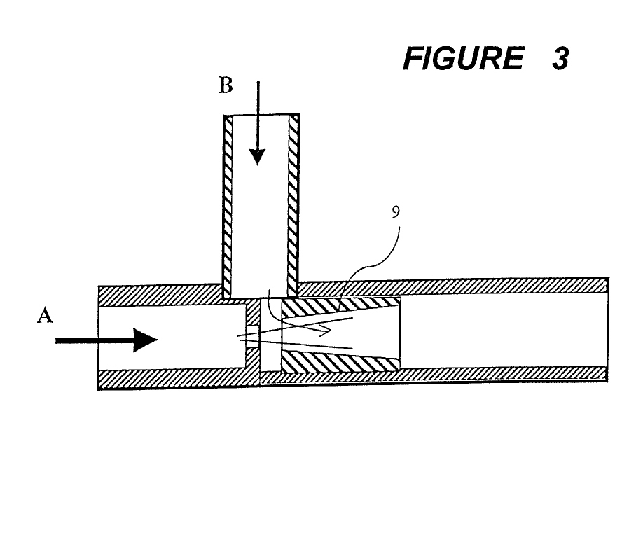

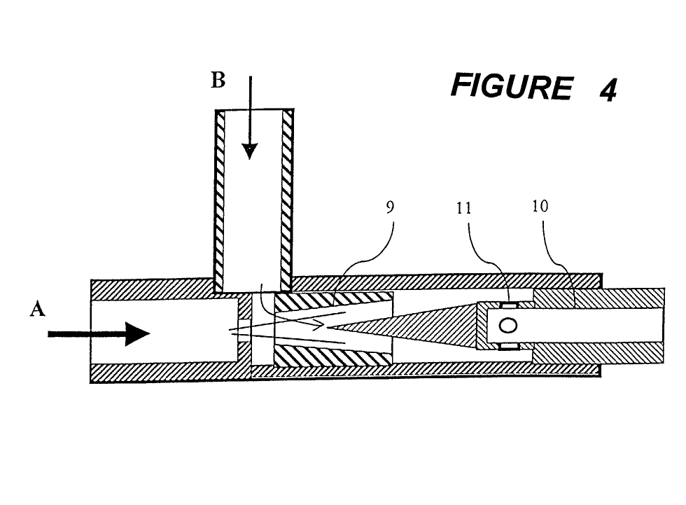

Particular embodiments of the mixing nozzle 5 are shown in FIGS. 2, 3, and 4. Here, A denotes the continuous and B the discontinuous phase. Particular preference is given to the three-step mixing nozzle shown in FIG. 4 in which the mixing chamber 9 is directly linked to a homogenizing device 10 and in which, at an admission pressure in the mixing chamber of generally 2 to 200 bar, the pressure of the pre-emulsion is reduced to a lower pressure, generally close to atmospheric pressure, via small openings 11.

The emulsions of the invention may be supplied for a large number of possible uses, some of which some may be listed by way of example:

Use in the field of the protection of materials, in particular the protection of wood, is characterized in that active compound-containing emulsions according to the invention based on bioactive, particularly organic fungicidally active compounds as component (a) are finely dispersed in water-based binder solutions or dispersions, using the processes mentioned above. The active compound-containing emulsions according to the invention have high chemical (for example, hydrolytical) and physical stability in combination with a fine distribution that is very good for the development of the active compound, and, accordingly, the emulsions are highly superior to purely aqueous formulations of the active compounds. Moreover, the active compounds penetrate the wood deeply and permanently. Particular preference is given here to using the active compound-containing emulsions for providing wood, in particular fresh wood, with fungicidal protection, and for impregnation. To this end, emulsions according to the invention in the form of concentrates in water are diluted to the desired strength, and these dilutions are applied to wood by means of the immersion, brushing-on, or pressure impregnation process, where in particular emulsions according to the invention in the form of microemulsions have good active compound penetration and a long-term stability of the active compound.

The use of the emulsions according to the invention in the agricultural field is characterized, for example, in that the emulsions based on biocidal active compounds of component (a) are dispersed in water by stirring, shaking, pumping, etc., in a concentration of less than 10% by weight (preferably less than 5% by weight, and more preferably less than 2% by weight) and are applied to plant and cultivation areas, generally by means of pump sprays. Here, the preparations are tolerated very well, and the dispersion is, in the dilution ranges indicated, considerably more stable than suspension concentrates. Surprisingly, it has been found that the preparations wet the surface of the plants particularly well and, after drying, form a sufficiently water-resistant film in which the active compounds are bound for a sufficiently long period of time.

Using the microemulsions or emulsions according to the invention, it is quite generally possible to prepare low-emission, in particular low-odor and/or odorless, formulations of active compounds.

If the emulsions according to the invention comprise disperse dyes or solvent dyes as active compounds, they can be used in principle for dyeing natural or synthetic materials.

A preferred use form of such “dye-containing” emulsions is ink jet printing.

Ink jet printing is known and generally takes place by the printing ink being introduced into the receiving vessel of an ink jet printing head and sprayed in small droplets onto the substrate. The ejection of ink in droplet form takes place preferably by way of piezoelectric crystal, a heated cannula (bubble-jet or thermo-jet technique) or mechanical pressure increase, in which case pressure is exerted onto the ink system and, accordingly, ink drops are ejected. The droplets from one or more small nozzles are fired in a targeted fashion onto the substrate, such as paper, wood, textiles, plastic, or metal, for example. Under electronic control, the individual droplets are brought together on the substrate to form text or graphic patterns.

Also possible is a technique in which very small volumes in the form of drops are brought from an ink jet onto a substrate by means of electrostatic deflection.

A method of using the dye-containing emulsions of the invention as printing inks is preferably characterized in that the printing inks are sprayed continuously or discontinuously onto a substrate to form drops. The process is particularly characterized in that the drops are generated using the computer-controlled thermal or piezoelectric ink jet printing process.

Preference is given to the use of the printing inks, wherein the substrates used are coated and uncoated papers, photographic papers, polymeric films, foils, and also textiles, glass, and metal. The emulsions, in particular microemulsions, used as printing inks give particularly brilliant color-intensive prints for which water and solvent fastness (marker fastness) is far superior to that of conventional printing inks based on soluble dyes or else pigments.

The dye-containing emulsions can also be used as colorants for ink jet printing in order to effect transfer of disperse dyes, in particular carboxylic acid and/or sulfonic acid group-free anthraquinone, azo-, and/or indoaniline-type disperse dyes, to a carrier or a color ribbon for thermo-transfer printing. In thermotransfer printing, a donor ribbon and a receiver (generally paper, polymer-coated (for example, PES- or PVC-coated) paper or polymeric films or carton) are brought into close contact with a thermal head (temperature >300° C.) by means of smooth rollers. Within a few msec, the dye is transferred owing to thermally induced diffusion along a concentration gradient from the donor ribbon into or onto the receiver to be printed.

The amount of dye taken up is controlled by the duration and the intensity of heating. Suitable receivers are, in principle, all temperature-stable plastic layers that have an affinity to the dyes to be transferred and for which the glass transition temperature is preferably in a temperature range of from 50 to 100° C., in particular polyesters and polycarbonates. After coating, the substrate is frequently coated with a polymeric film, for protection against abrasion.

The method of thermotransfer printing is also described, for example, in “Ullmann's Encyclopaedia of Industrial Chemistry”, Sixth Edition, 1999 Electronic Release.

For printing the donor ribbon by means of the ink jet process, the dye-containing emulsions can be used either without further additives or else in aqueous mixture with a polymeric binder and, if appropriate, additional water-soluble solvent. Suitable polymeric binders are, for example, those based on polyisocyanates or polyacrylates and, in particular, ethyl cellulose, ethyl hydroxy ethyl cellulose, polyvinyl butyrate, or polyvinyl acetate.

The following examples further illustrate details for the preparation and use of the compositions of this invention. The invention, which is set forth in the foregoing disclosure, is not to be limited either in spirit or scope by these examples. Those skilled in the art will readily understand that known variations of the conditions and processes of the following preparative procedures can be used to prepare these compositions. Unless otherwise noted, all temperatures are degrees Celsius and all parts and percentages are parts by weight and percentages by weight, respectively. EXAMPLES

### Examples 1 to 12

### (see Tables 1 and 2)

To prepare the discontinuous organic phase, organic active compounds of component (a) were dissolved completely, if appropriate at elevated temperature, in organic compounds of component (b) and, if appropriate, solvent of component (c).

The resulting oil phase was then introduced into the aqueous-organic continuous phase and dispersed for about 0.5 minutes using a high-speed stirrer while maintaining the temperature.

Table 1 and Table 2 show the compositions and the evaluation of the resulting emulsions.

The emulsions of Examples 1 to 12 are particularly distinguished by the fact that the content of the solids dissolved in the emulsified oil phase at room temperature is considerably higher than the solubility limit of the solids in the pure (non-emulsified) oil phase. The observed slight recrystallization at room temperature, which occurs due to handling, stops after a short while. It can be prevented altogether by carrying out the process continuously, as described in Examples 13, 14, and 15.

The emulsions according to Examples 1 to 12 could readily be introduced into tap water, for example, by shaking or stirring, to concentrations of down to below 0.1% by weight, giving homogeneous dispersions (spray liquors) that were stable for more than 3 days both against sedimentation of the active compounds and against creaming of an oil phase. The good dispersion stability of the spray liquors was maintained even under conditions of constant shearing and pumping.

This preparation of solids was accordingly particularly suitable for application using agriculturally customary spraying equipment, combining good compatibility and particularly high biological activity.

Illustrations:

Active Compounds of Component (a)

Active Compound 1: Crop Protection Agent 3-{1-{[2-(4-(2-chlorophenoxy)-5-fluoropyrimid-6-yloxy)phenyl]-1-(methoxyimino)methyl}-5,6-dihydro-1,4,2-dioxazine of the formula

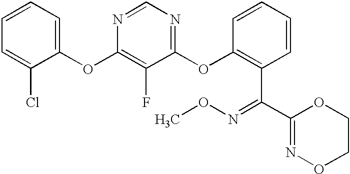

known from WO-A-97-27189,

Active compound 2: Fungicide tebuconazole (Folicur®, Bayer AG) having a residual humidity of <1% by weight,

Active compound 3: Fungicide propiconazole (WOCOSEN® Technical, from Janssen)

Compounds of Component (b)

Compound 1: Compound according to formula 1) where R₁₅, R₁₆, and R₁₈ are H, mis 2.7, and n is 10

Compound 2: Compound based on gum rosin reacted with on average 5 mol of units of ethylene oxide per mole of gum rosin

Compound 3: Compound based on lauryl alcohol reacted with on average 3 mol of units of ethylene oxide per mole of lauryl alcohol.

Surfactants of component (f)

Emulgator® KS: alkoxylated castor oil fatty substance, Bayer AG

Statexan® NA 36% strength: alkoxylated sulfated fatty alcohol, Bayer AG; 36% strength aqueous solution adjusted to pH 8.5 with dilute NaOH

Atlox® 4894: alkoxylated fatty alcohol, from ICI

Impralit® TSK 17: compound according to formula XV, from Rutgers Organics; 32% strength aqueous solution

Dispersant VPSP25031: ionically modified phenol/styrene polyglycol ether prepared as described in Example 10 of WO-A-9937718

Block Copolymer of Component (g)

Pluronic® PE 6800: polyethylene oxide/polypropylene oxide block copolymer, BASF AG

### Example 13

### Continuous Preparation of Microemulsions

A microemulsion of composition according to Example 5 was prepared by the process shown in FIG. 1 using a three-step mixing nozzle according to FIG. 4 with an integrated jet disperser (homogenizer nozzle) having 0.2 mm openings. The preparation and the composition of the discontinuous and continuous phases also corresponded to Example 5; the admission pressure in mixing chamber 7 was 12 bar. The temperature of the discontinuous phase was about 90 to 1 1 50C when it entered mixing chamber 7; the temperature of the continuous phase was 240C.

The resulting microemulsion was completely stable for more than 4 weeks and showed no form of recrystallization.

### Example 14

### Continuous Preparation of Microemulsions

A microemulsion of composition according to Example 9 was prepared by the process shown in FIG. 1 using a three-step mixing nozzle according to FIG. 4 with an integrated jet disperser (homogenizer nozzle) having 0.2 mm openings. The preparation and the composition of the discontinuous and continuous phases also corresponded to Example 9; the admission pressure in mixing chamber 7 was 8 bar. The temperature of the discontinuous phase was about 85 to 110° C. when it entered mixing chamber 7; the temperature of the continuous phase was 22° C.

The resulting microemulsion was completely stable for more than 4 weeks and showed no form of recrystallization.

### Example 15

### Continuous Preparation of Microemulsions

A microemulsion of composition according to Example 12 was prepared by the process shown in FIG. 1 using a three-step mixing nozzle according to FIG. 4 with an integrated jet disperser (homogenizer nozzle) having 0.2 mm openings. The preparation and the composition of the discontinuous and continuous phases also corresponded to Example 12; the admission pressure in mixing chamber 7 was 8 bar. The temperature of the discontinuous phase was about 85 to 110° C. when it entered mixing chamber 7; the temperature of the continuous phase was 22° C.

The resulting microemulsion was completely stable for more than 4 weeks and showed no form of recrystallization.

### Example 16

### Odorless Formulation of a Disinfectant

(p indicates parts by weight)

On a magnetic heater/stirrer, at a temperature of 75° C.,

59 p of compound 1 (as described in Example 1-12, compound of component (b)) were initially charged and

114.5 p of 3-methyl-4-chlorophenol (Preventol® CMK, Bayer AG, disinfectant of comp. (a)) and

0.5 p of eucalyptol were completely dissolved therein.

On a magnetic stirrer,

25 p of the above solution (oil phase) with a temperature of 50° C. were then introduced slowly, with vigorous mixing, into an aqueous-organic continuous phase in the form of a solution, at room temperature, comprising

69 p of water

6 p of Pluronic® PE 6800

30 p of Emulgator® KS

15 p of dispersant VPSP 25036: ionically modified phenol/styrene polyglycol ether prepared as described in Example 8 of EP-A 839 879

15 p of N-methylpyrrolidone

and emulsified. This gave a microemulsion that was completely stable in a temperature range of up to 50° C. and had an active compound content of about 10.3% and that could readily, without further additives, be diluted with water to give storage-stable dilutions having desired active compound concentrations of less than 0.5% by weight. In contrast to the non-emulsified oil phase, in particular, no recrystallization of the active compound was observed, either in the emulsion concentrate (microemulsion according to the invention) or in the aqueous dilutions. The emulsion concentrate had a pleasantly mild odor; the unpleasant odor of the active compound itself was eliminated. Microemulsions prepared by the same process, but without any eucalyptol in the oil phase, did likewise not smell of active compound.

TABLE 1

| | | | | | | | | |
|---|---|---|---|---|---|---|---|---|
| Example | 1 | 2 | 3 | 4 | 5 | 6 | 7 | 8 |

Composition discontinuous oil phase:

| | | | | | | | | | |
|---|---|---|---|---|---|---|---|---|---|
| comp. a) | active compound 1 | 18% | 35% | 35% | 35% | | | | |
| | active compound 2 | | | | | 50% | 50% | 50% | 50% |
| | active compound 3 | | | | | | | | |
| comp. b) | compound 1 | 32% | 65% | 65% | 65% | 50% | 50% | 50% | 50% |
| | compound 2 | | | | | | | | |
| | compound 3 | 25% | | | | | | | |
| comp. c) | rapeseed oil methyl ester | 25% | | | | | | | |
| | 1,2-propanediol diacetate | | | | | | | | |
| Temperature | | 115° C. | 115° C. | 115° C. | 115° C. | 115° C. | 115° C. | 115° C. | 115° C. |

Composition continuous phase:

| | | | | | | | | | |
|---|---|---|---|---|---|---|---|---|---|
| comp. d) | deionized water | 99,9% | 75,90% | 98,00% | 70,70% | 17,10% | 89,10% | 48,10% | 93,50% |
| comp. f) | Emulgator ® KS | | 24,00% | 2,00% | | | | | |
| | Statexan ® NA 36% | | | | | | | | |
| | strength aqu. | | | | | | | | |
| | Atlox ® 4895 | | | | 25,00% | | | | |
| | Impralit ® TSK 17 32% | | | | | 78,60% | 10,30% | 48,10% | 6,00% |
| | strength aqu. | | | | | | | | |
| | Dispersant VPSP 25031 | | | | | | | | |
| comp. g) | Pluronic ® PE 6800 | | | | 4,30% | 4,30% | 0,60% | 3,80% | 0,50% |
| Additive | silicone antifoam | 0,10% | 0,10% | | | | | | |
| Temperature | | RT | RT | RT | RT | RT | RT | RT | RT |

Emulsion:

| | | | | | | | | | |
|---|---|---|---|---|---|---|---|---|---|
| | type | macro e. | mini e. | macro e. | micro e. | micro e. | micro e. | micro e. | mini e. |
| | discontinuous phase | 2,00% | 19,40% | 2,00% | 6,70% | 7,30% | 1,00% | 11,90% | 1,70% |
| | continuous phase | 98,00% | 80,60% | 98,00% | 93,30% | 92,70% | 99,00% | 88,10% | 98,30% |
| | | | | | 0.45 μm. | | 0.45 μm. | | 0.45 μm. |
| filtration | | no | no | no | good | no | good | no | good |

Assessment emulsion:

| | | | | | | | | | |
|---|---|---|---|---|---|---|---|---|---|
| | Initial consistency | homog- | homog- | homog- | clear | clear | clear | clear | homogeneous |
| | | eneous | eneous | eneous | good liquid | gel-like/ | low liquid | gel-like/ | low liquid |
| | | liquid | still liquid | low liquid | | liquid | | liquid | |
| after 1 week at RT | microscope drop size | 1-5 μm | (n.d.) | 1-5 μm | (n.d.) | (n.d.) | (n.d.) | (n.d.) | (n.d.) |
| after 1 week at RT | microscrope crystals | trace | no | trace | no | no | no | no | no |
| after 1 week at RT | separation of emulsion | no | no | no | no | no | no | no | no |
| after 1 week at RT | crystalline sediment | no | no | no | no | trace | no | trace | no |
| after 2 weeks at RT | crystalline sediment | no | no | no | no | unchanged | no | unchanged | no |

Assessment discontinuous oil phase:

| | | | | | | | | | |
|---|---|---|---|---|---|---|---|---|---|
| after 1 week at RT | viscosity | still liquid | high | high | high | high | high | high | high |
| | | | viscosity | viscosity | viscosity | viscosity | viscosity | viscosity | viscosity |
| | recrystallization | much | much | much | much | much | much | much | much |

[% = % by weight]

TABLE 2
[% = % by weight]

| Example | | 9 | 10 | 11 | 12 |
|---|---|---|---|---|---|
| Composition discontinuous oil phase: | | | | | |
| comp. a) | active compound 1 | | | | |
| | active compound 2 | 60% | 60% | 60% | 60% |
| | active compound 3 | | | | |
| comp. b) | compound 1 | | | | |
| | compound 2 | 40% | 40% | 40% | 40% |
| | compound 3 | | | | |
| comp. c) | rapeseed oil methyl ester | | | | |
| | 1,2-propanediol diacetate | | | | |
| Temperature | | 110° C. | 110° C. | 110° C. | 110° C. |
| Composition continuous phase: | | | | | |
| comp. d) | deionized water | 17.1% | 70.70% | 17.10% | 70.70% |
| comp. f) | Emulgator ® KS | | 25.00% | | |
| | Statexan ® NA 36% strength aqu. | | | 78.60% | |
| | Atlox ® 4895 | | | | 25.00% |
| | Impralit ® TSK 17 32% strength aqu. | 78.60% | | | |
| | Dispersant VPSP 25031 | | | | |
| comp. g) | Pluronic ® PE 6800 | 4.30% | 4.30% | 4.30% | 4.30% |
| Additive | silicone antifoam | | | | |
| Temperature | | RT | RT | 70° C. % | RT |
| Emulsion: | type | micro e. | mini e. | mini e. | micro e. |
| | discontinuous phase | 13.00% | 10.30% | 6.70% | 6.70% |
| | continuous phase | 87.00% | 89.7% | 93.30% | 93.30% |
| filtration | | no | no | no | 1.2 μm, good |
| Assessment emulsion: | Initial consistency | clear | nematic | homogeneous | clear |
| | | low liquid | liquid | liquid | liquid |
| after 1 week at RT | microscope drop size | (n.d.) | (nd.) | <1-5 μm | (n.d.) |
| after 1 week at RT | microscrope crystals | no | no | no | occasionally |
| after 1 week at RT | separation of emulsion | no | some | no | no |
| after 1 week at RT | crystalline sediment | trace | no | no | trace |
| after 2 weeks at RT | crystalline sediment | unchanged | no | no | unchanged |
| Assessment discontinuous oil phase: | | | | | |
| after 1 week at RT | viscosity | high viscosity/ | high viscosity/ | high viscosity/ | high viscosity/ |
| | | solid | solid | solid | solid |
| | recrystallization | some | some | some | some |

What is claimed is:

1. An emulsion of an aqueous or aqueous-organic continuous phase and an organic discontinuous phase, wherein the organic discontinuous phase comprises
(a) at least one organic active compound having a water solubility at 20° C. of <10 g/l, and
(b) at least one organic compound having a water solubility at 20° C. of <1 g/l selected from the group consisting of a products of the reaction of alkylene oxides with alkylatable compounds, and
(c) optionally, a water-immiscible organic solvent, wherein component (a) is completely dissolved in component (b), or, when component (c) is present, in components (b) and (c) together, with a content of more than 0.1% by weight, at 20° C., based on the total weight of the organic phase.

2. An emulsion according to claim 1 wherein the alkylatable compounds are fatty alcohols, fatty amines, fatty acids, phenols, alkylphenols, carboxamides, or resin acids.

3. An emulsion according to claim 1 comprising, based on the total emulsion,
(1) from 1 to 40% by weight of the discontinuous organic phase, and
(2) from 60 to 99% by weight of the continuous aqueous or aqueous-organic phase.

4. An emulsion according to claim 1 wherein the continuous aqueous or aqueous-organic phase comprises
(d) water,
(e) optionally, an organic solvent, and
(f) optionally, a natural or synthetic surfactant having a solubility in water >10 g/l at 20° C.

5. An emulsion according to claim 1 additionally comprising, based on the discontinuous organic phase,
(e) from 0 to 600% by weight of one or more water-soluble organic solvents,
(f) from 0 to 2000% by weight of one or more water-soluble surfactants, and
(g) from 0 to 100% by weight of one or more water-soluble block copolymers, and optionally, further additives.

6. An emulsion according to claim 1 that is a microemulsion.

7. An microemulsion according to claim 6 additionally comprising, based on the discontinuous organic phase,
(e) from 0 to 600% by weight of one or more water-soluble organic solvents,
(f) from 10 to 2000% by weight of one or more water-soluble surfactants, and
(g) from 0 to 100% by weight of one or more water-soluble block copolymers, and optionally, further additives.

8. An emulsion according to claim 1 additionally comprising, as a surfactant component (f), an amphoteric surfactant selected from the group consisting of betaines and ampholytes.

9. An emulsion according to claim 8 wherein the surfactant component (f) is a boric ester.

10. An emulsion according to claim 8 wherein the surfactant component (f) is a boric ester of formula (XV) 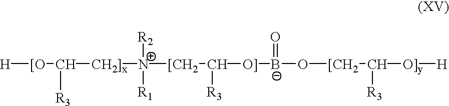
where
x and y are each a number from 1 to 50,
R₁ and R₂ are linear or branched C₆-C₁₈-alkyl, and R₃ are each identical or different and represent hydrogen, CH₃, or phenyl, subject to the proviso that (i) when CH₃ is present in the various —(—CH₂—CH(R³)—O—)— groups, then 0 to 60% of the total R³ is CH₃ and 40 to 100% of the total R³ is hydrogen and (ii) when phenyl is present in the various —(—CH₂—CH(R³)—O—)— groups, then 0 to 40% of the total R³ is phenyl and 60 to 100% of the total R³ is hydrogen.

11. An emulsion according to claim 1 wherein the compounds of component (b) have an arithmetic HLB value of less than 12 and are products of the reaction of ethylene oxide and/or propylene oxide with
(b1) saturated and/or unsaturated fatty alcohols having 6 to 25 carbon atoms or
(b2) alkylphenols having 4 to 12 carbon atoms in the alkyl radical or
(b3) saturated or unsaturated fatty amines having 14 to 20 carbon atoms or
(b4) saturated and/or unsaturated fatty acids having 14 to 22 carbon atoms or
(b5) hydrogenated and/or non-hydrogenated resin acids, particularly gum rosin or abietic acid and turpentine resin,
(b6) esterification and/or arylation products, prepared from natural or modified, optionally hydrogenated castor oil fatty substances, wherein these products have optionally been linked by esterification with dicarboxylic acids to form structural repeating units, and
(b7) alkoxylated phenols.

12. An emulsion according to claim 11 wherein the compound of component (b) is a product of the reaction of ethylene oxide and/or propylene oxide with phenol/styrene polyglycol ethers of the formula (I) or of the formula (II) 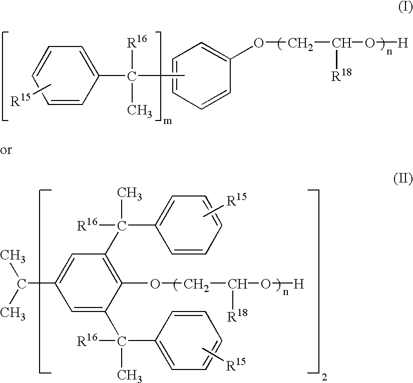
wherein
R¹⁵ represents hydrogen or C₁-C₄-alkyl,
R¹⁶ represents hydrogen or CH₃,
R¹⁷ represents hydrogen, C₁-C₄-alkyl, C₁-C₄-alkoxy, C₁-C₄-alkoxy-carbonyl, or phenyl,
m represents a number from 1 to 4,
n represents a number from 2 to 13,
R¹⁸ for each unit indicated by n is identical or different and represents hydrogen, CH₃, or phenyl, subject to the proviso that (i) when CH₃ is present in the various —(—CH₂—CH(R¹⁸)—O—)— groups, then 0 to 60% of the total R¹⁸ is CH₃ and 40 to 100% of the total R¹⁸ is hydrogen and (ii) when phenyl is present in the various —(—CH₂—CH(R¹⁸)—O—)— groups, then 0 to 40% of the total R¹⁸ is phenyl and 60 to 100% of the total R¹⁸ is hydrogen.

13. A process for preparing an emulsion according to claim 1 comprising
(1) completely dissolving an active compound (a) at a temperature of from 20 to 200° C. in the organic compound (b), optionally using a solvent (c), and optionally filtering the solution at a temperature of from 20 to 200° C., to obtain a solution,
(2) emulsifying the resulting solution in the aqueous or aqueous-organic phase,
(3) cooling the resulting emulsion to a temperature of from 10 to 70° C. and optionally filtering the emulsion.

14. A process according to claim 13 wherein the emulsion is prepared using ultrasound or high-pressure homogenization or jet dispersion at pressures of from 2 to 2500 bar in one or more passes.

15. A process according to claim 13 wherein the continuous and the discontinuous phase are prepared separately and then combined and emulsified continuously in a mixing nozzle and/or homogenizing nozzle and the emulsion or microemulsion is optionally immediately afterwards cooled to a temperature of from 20 to 70° C.

16. A method of protecting a material comprising applying an emulsion according to claim 1 to the material.

17. A method according to claim 16 wherein the material is wood.

18. A method of protecting a plant area or a cultivated area comprising applying an emulsion according to claim 1 to the plant area or cultivated area.

19. A method of protecting a pharmaceutical composition comprising introducing an emulsion according to claim 1 to the pharmaceutical composition.

20. A method of dyeing a natural or synthetic material comprising applying an emulsion according to claim 1 to the material.

21. A method according to claim 20 wherein a dye is applied by an ink jet printing or thermotransfer printing process.

22. An emulsion according to claim 1 wherein component (a) comprises from 0.1 to 30% by weight of 3-methyl-4-chlorophenol.

23. An emulsion according to claim 1 wherein component (a) comprises from 0.05 to 25% by weight of tebuconazole and/or propiconazole.
